(19) United States
(12) Patent Application Publication
(10) Pub. No.: US 2025/0222797 A1
(43) Pub. Date: Jul. 10, 2025

(54) Locking Device for a Charging Plug of an Electric Vehicle Charging System using the J3400 Standard

(71) Applicant: Wing Kwong, Burnaby (CA)

(72) Inventor: Wing Kwong, Burnaby (CA)

(21) Appl. No.: 19/009,975

(22) Filed: Jan. 4, 2025

Related U.S. Application Data
(60) Provisional application No. 63/618,988, filed on Jan. 9, 2024.

(51) Int. Cl. B60L 53/16; H01R 13/639

(52) U.S. Cl. CPC B60L 53/16; H01R 13/639; B60L 2270/32

(57) ABSTRACT

A plug-locking device for an electric vehicle charging plug using J3400 standard. The main component of the plug-locking device consists of an outer shell, an inner shell, and a locking latch. The plug-locking device has two positions: Open and Close. In the Open position, the locking latch will be retracted into a chamber, allowing the charging plug to move freely into and out of the plug lock. In the Close position, when the charging plug is inserted, the latch will advance into the lower slot of the electrical plug, preventing the plug from being removed from the device. The inner shell has a lock anchor that passes through the outer shell. A user can install a lock at the end through this anchor to prevent the outer shell from sliding back into the open position and therefore, preventing the plug from being removed from the plug lock.

### BACKGROUND OF INVENTION

Electric vehicles are becoming more and more popular among households. More and more private charging stations are being installed at residential and commercial properties. Each charging station comes with a charging plug, which connects to an electric vehicle in order to transfer electricity from the station to the vehicle's battery. More and more car companies are now adopting the J3400 Standard plug for charging their vehicles (or otherwise known as the North American Charging Standard, or NACS for short). However, there is a lack of after-market accessories to prevent unauthorized use of such facilities. Anyone can drive up to a parking lot close to or adjacent to a charging station and use the facility, as long as the electrical cord is long enough. This invention allows the charging plug to be locked with a padlock, and allows only authorized users to use the charging stations.

To provide some background, the J3400 standard electrical plug consists of an almost-oval shape plug (FIG. 1) and an opening slot at the bottom (FIG. 2). For electric vehicles that adapt to this standard, there will be a notch (4) that pops up from the charging port that goes into the slot (3) under the bottom of the plug (1), locking the plug to the port (2) of the vehicle while it is being recharged. The plug itself can be connected to a vehicle with a battery that requires charging from such stations and remains locked.

When the electrical plug is not being used, usually it gets stored in a holster or just simply left hanging on the wall. However, anyone can walk up and remove the electrical plug from the holster and attach the electrical plug onto their own vehicles. Although for certain charging stations, access can be controlled through software control, each software has its own limitation (e.g. some charging stations can have a limit of up to 10 vehicles to restrict access). This invention is simple, requires no extra external power source or software update, and allows the charging plug to be locked with a standard padlock, preventing unauthorized users from using the charging stations.

### SUMMARY OF THE INVENTION

The main purpose of this invention is to prevent unauthorized use of electrical charging stations by disallowing the charging plug from connecting to an unauthorized electric vehicle. It pertains to a component that can be secured onto an existing J3400/North American Charging Standard electrical plug at privately owned charging stations.

The main component consists of an outer shell, an inner shell, and a locking latch. The inner shell can be slided freely along the side tracks of the outer shell. When the inner shell is in the opened position, the locking latch will retract and the electrical plug can slide fully into or out of the inner shell. When the user slides the outer shell over the inner shell into the close position, the locking latch will automatically be inserted into the J3400 plug's locking slot, preventing the plug from being removed from the plug lock. A user will then install a padlock or key lock at the end of the plug lock to prevent the outer shell from sliding back into the open position.

### DESCRIPTION OF THE SEVERAL VIEWS OF THE DRAWING

FIG. 1 is a prior art of a J3400/NACS plug and a J3400/NACS port.

FIG. 2 is a prior art of a J3400/NACS charging port, with the locking latch being raised as a demonstration.

FIG. 3 is a prior art of the J3400/NACS plug's bottom view, showing the opening slot underneath the plug.

FIG. 4 is the front view of the invention, showing the front lock anchor and the outer shell.

FIG. 5 is a side view of the present invention in the close configuration, showing the front lock anchor and the outer shell. It also shows the tracks of the outer shell where the inner shell can move along upon.

FIG. 6 is a side view of the present invention in the open configuration, showing the front lock anchor retracting into the outer shell through the open hole. It also shows the inner shell sliding away from the outer shell via its tracks.

FIG. 7 is a side elevational view of the present invention in the open position, showing the front lock anchor of the inner shell retracting into the outer shell. It also shows how the inner shell can move along the tracks of the outer shell

FIG. 8 is a side elevational view of the present invention in the close position, showing the front lock anchor of the inner shell passing through the opening of the outer shell. A lock is artificially applied to demonstrate that the lock anchor cannot be retracted into the outer shell, preventing the inner shell from sliding away from the outer shell.

FIG. 9 is a side elevational view of the present invention in the close position, showing the locking latch popping up from the opening of the inner shell.

FIG. 10 is a side elevational view of the present invention in the open position, showing the locking latch retracting from the inner shell into the lower chamber.

FIG. 11 is a side translucent view of the present invention in the open position, showing the pushing notch on the outer shell rotating the locking latch, causing it to retract from the inner shell and allowing the inner shell to receive the electrical plug.

FIG. 12 is a side translucent view of the present invention in the close position, showing the pushing notch actuating the locking latch into the inner shell and inserting it into the bottom slot of the electrical plug

FIG. 13 is a side bottom view of the present invention in the open position, showing the emergency release notch.

### DETAILED DESCRIPTION OF THE INVENTION

Although the invention will be described in connection with certain preferred representations, it will be understood that the invention is not limited to those particular representations. The invention is intended to cover all alternatives, modifications, and equivalent arrangements as may be included within the spirit and scope of the invention as defined by the items listed under Claims.

In the following details and claims, the term J3400, North American Charging Standard, and NACS may be used interchangeably. They all refer to the same standards for the shape and dimension of an electrical plug used to charge an electric vehicle.

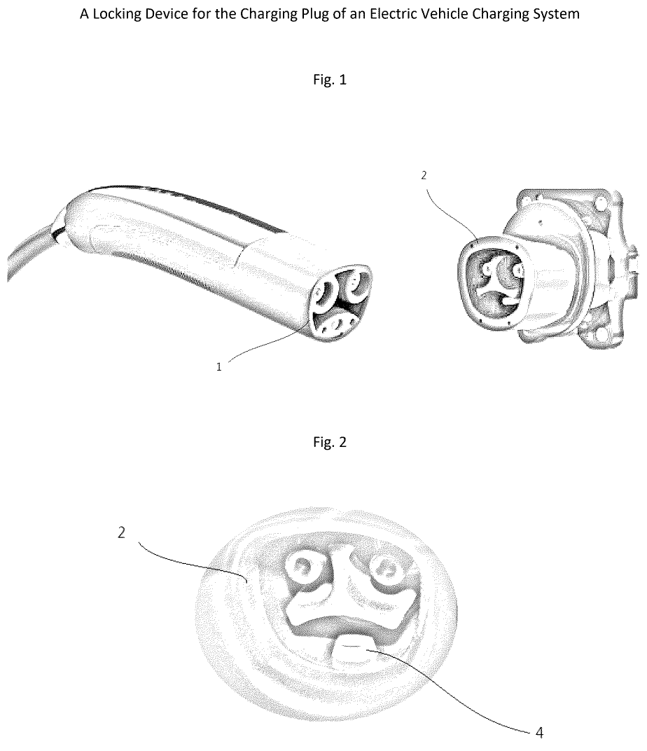

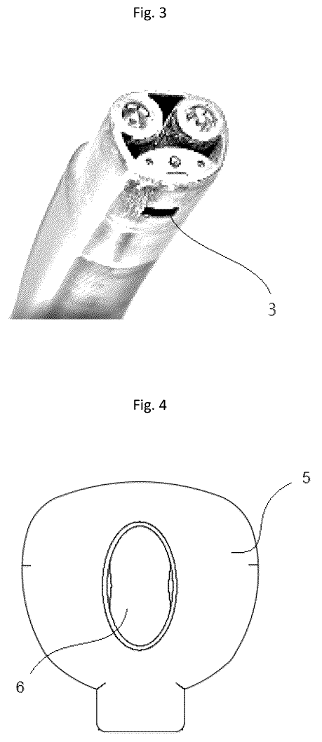

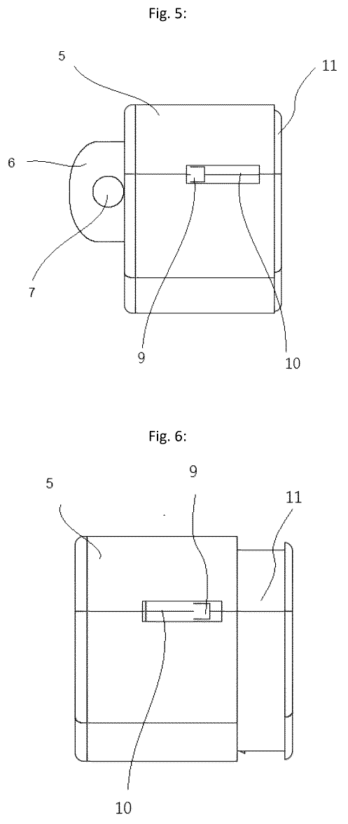

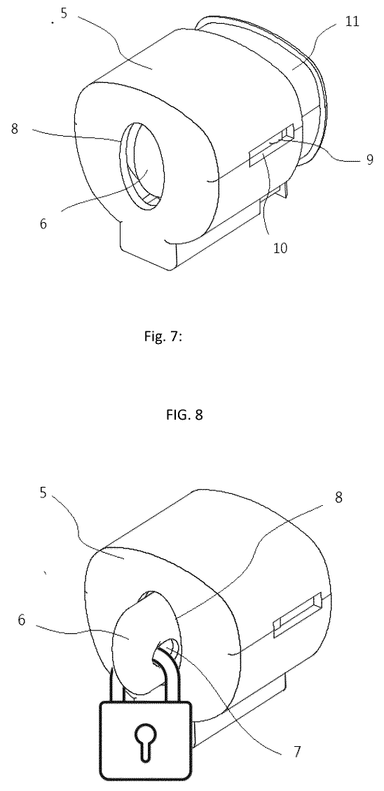

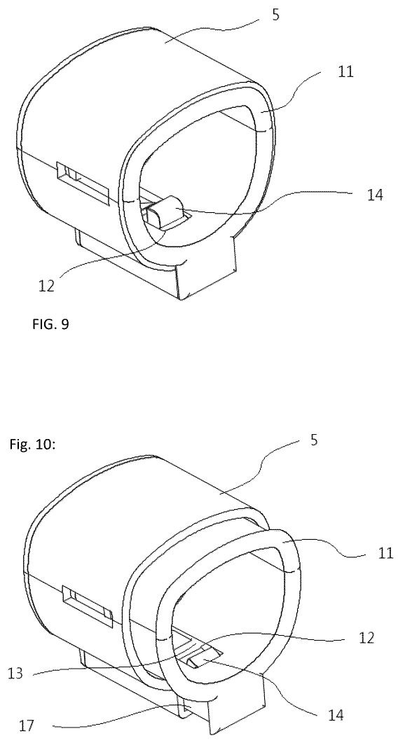

A locking device for a charging plug that follows the J3400 standard is described. The charging plug itself can be removed from a charging station and connected to an electric vehicle for charging the vehicle's battery. To provide some context, FIGS. 1, 2 and 3 illustrate an example of an existing charging plug from a charging station and the port on a vehicle that uses the J3400 standard. This charging plug type has an interface (#1) that can be inserted into a J3400-shaped port (#2) located on a charging vehicle. The way the charging plug is secured onto the charging vehicle is by the means of a locking latch (#4) that pops up from the bottom of the charging port. All charging plug adopting to this standard will have an opening slot at the bottom (#3). When charging is initiated, the lock (#4) will be electrically controlled and popped up from its housing, inserting itself into the opening slot (#3) of the plug and therefore, securing the plug onto the vehicle being charged.

This invention is designed to provide a locking enclosure for the charging plug (#1) when it is not in use, ensuring that it cannot be attached onto a vehicle without authorization. With reference to the drawings, one embodiment of the invention mainly consists of an outer shell, an inner shell, and a retractable locking latch. The inner shell (#11) can slide in and out of the outer shell (#5) via tracks (#10). The locking device therefore has two positions. When the outer shell is slided away from the inner shell, it is in the open position; when the outer shell is slided toward the inner shell, it is in the close position.

To build the device, the inner shell (#11) will have a cylinder with the ending shape like a J3400 plug. This inner shell is made slightly larger than the plug itself so that the charging plug can be inserted into it. The inner shell has a slot opening at the bottom (#12). A rocker-type locking latch (#14) can be rotated around an axis (#13) within the said slot. Beneath the opening slot is a lower chamber (#17). The locking latch therefore can rotate into the inner shell, or rotate out of the inner shell into the lower chamber around this axis.

The inner shell has two small notches (#9) on the side. These allow the inner shell to slide along the tracks on the outer shell (#10) and allow the inner shell to be moved freely relative to the outer shell.

At the other end of the inner shell where it is not receiving the electrical plug, a lock anchor (#6) is provided so that a padlock can be installed at the anchor hole (#7). This lock anchor passes through an opening (#8) on the outer shell as the inner shell moves in relation to the outer shell.

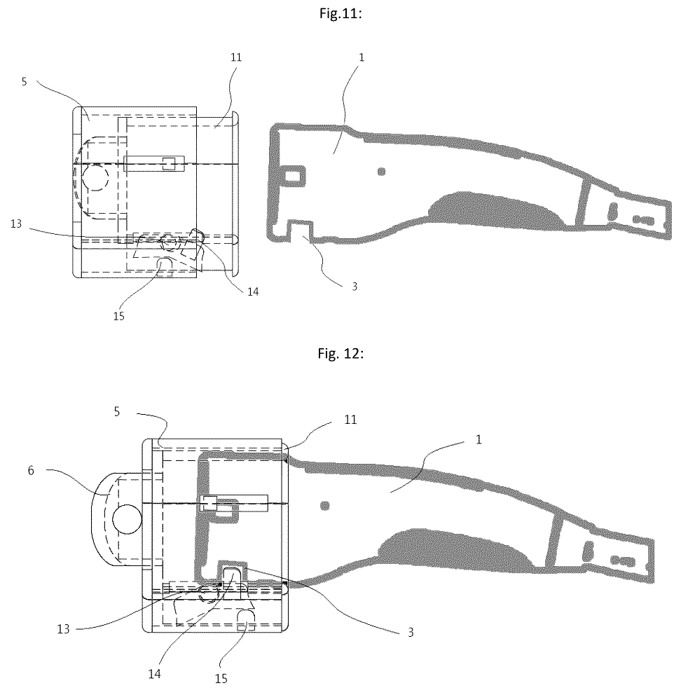

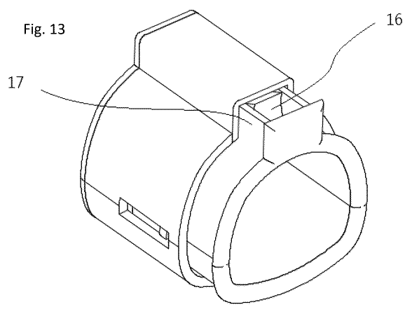

The outer shell is also in the shape of the J3400 plug and wraps around the inner shell. On one end, it is opened as well for receiving the electrical plug. On the other end, it has a small opening (#8) that allows the said lock anchor (#6) of the inner shell to pass through. At the bottom of the outer shell of the inside wall, there is a pushing notch (#15) that moves relative to the rocker-type locking latch (#14) attached to the inner shell, depending on whether the device is in the open or the close position. This pushing notch (#15) will push the rocking latch (#14) into the inner shell when the device is in the close position (FIG. 12). Alternatively, when the device is in the open position, the pushing notch (#15) will move to the opposite end of the rocking locking latch (#14), causing the locking latch to retract out of the inner shell (FIG. 11)

In order to use the charging plug, the locking device will need to be in the open position first. This allows the rocker-type latch (#14) to be retracted into the lower chamber (#17) through the inner shell's opening (#12). The electrical plug can then be fully inserted into the inner shell (FIG. 11). Next, the locking device will need to be in the close position (FIG. 12). This can be done by sliding the outer shell over the inner shell in the direction of the electrical plug. This in turn will slide the outer shell pushing notch (#15) into position where it will actuate the rocker-type latch (#14) upward, inserting the rocker-type latch into the electrical plug slot (#3). The entire device will then be secured by a padlock or key lock that gets installed at the anchor (#6). Since this anchor is attached to the inner shell and is exposed through an opening on the outer shell (#8), having a padlock at this anchor will prevent the outer shell from sliding away from the inner shell.

In order to remove the electrical plug from the plug lock, the padlock or key lock needs to be removed from the anchor point first (#7). This allows the locking anchor (#6) to be retract through the outer shell's opening (#8) and allows the device to be back into the Open position. When this is being done, the outer shell pushing notch (#15) will in turn push the rocker-type locking latch (#14) in the other direction, retracting the locking latch from the slot on the electrical plug (#3). In turn, the electrical plug is now free to be removed from the inner shell of the plug lock.

As described above, the locking latch (#14) will retract into the inner shell's lower chamber (#17) as it should when the device is in the Open position under normal circumstances. In case of emergency when somehow the pushing notch (#15) fails to cause the locking latch (#14) to retract and prevent the electrical plug (#1) from being released out of the inner shell, the lower chamber (#17) gives access to the rocker-type latch once the device is in its open position. This chamber can be accessed by turning the device upside down. User can then pry up the emergency release notch (#16) and force the locking latch (#14) to retract from the inner shell. When the locking latch is retracted, it is no longer in the electrical plug slot (#3) and therefore the electrical plug is freed to be removed from the device.

Although the embodiments of the present invention have been described in detail above, the present disclosure is used to help the overall understanding of the invention and is not limited to the above-described embodiments, and various design changes can be made without departmenting from the spirit of the present disclosure described in the claims.

1. The electrical vehicle charging plug lock is a standalone device that comprises of:
an inner shell in the shape of a J3400-standard electrical plug;
an outer shell that slides around the said inner shell and
a locking latch.

2. The locking device of claim 1 of the said inner shell further comprises an opening that allows the said locking latch to insert into or retract from the inner shell.

3. The locking device of claim 1 of the said inner shell can slide into a Close position or slide away from the said outer shell into the Open position through designated tracks.

4. The locking device of claim 1 of the said Inner shell can be secured into the Close position in relation to the said outer shell by the means of a locking anchor, allowing a padlock to be installed and preventing the said inner shell from sliding away from the said outer shell.

5. The locking device of claim 1 of the said locking latch can be actuated by a pushing notch located on the outer shell so that it gets inserted into or retracted out of the inner shell, depending on the notch's relative position to the inner shell.

6. The locking device of the said locking latch further comprises an emergency release notch which provides an alternative method for retracting the locking latch from the inner shell.

7. The locking device comprises a chamber which gives access to the emergency release notch.
